(19) United States
(12) Patent Application Publication
(10) Pub. No.: US 2026/0175888 A1
(43) Pub. Date: Jun. 25, 2026

(54) FOLDABLE CART

(71) Applicant: Foshan BeeKoo Intelligent Technology Co.,Ltd, Foshan (CN)

(72) Inventor: HUASHENG CHEN, Foshan (CN)

(21) Appl. No.: 19/019,664

(22) Filed: Jan. 14, 2025

(30) Foreign Application Priority Data
Dec. 23, 2024 (CN) 202411900783.9

(51) Int. Cl. B62B 3/02

(52) U.S. Cl. CPC B62B 3/02; B62B 2205/20

(57) ABSTRACT

The present invention relates to a foldable cart comprising a functional frame component and a bottom frame component; the functional frame component includes a front functional frame and a rear functional frame; both the front functional frame and rear functional frame are provided with a roller; the bottom frame component includes a front bottom frame and a rear bottom frame; one end of front bottom frame is horizontally hinged to the front functional frame, and one end of rear bottom frame is horizontally hinged to the rear functional frame. The present invention can ensure uniform force distribution on the functional frame component while maintaining the stability foldable cart in an unfolded state, and improve the overall strength of functional frame components under the same consumables, and also ensure the stable posture of the front and rear bottom frames being parallel to each other when folded.

### CROSS-REFERENCE TO RELATED APPLICATIONS

This application claims priority to Chinese Patent Application No. 202411900783.9, filed on Dec. 23, 2024, which is hereby incorporated by reference in its entirety.

### TECHNICAL FIELD

The present invention relates to the field of cart technology, particularly to a foldable cart.

### BACKGROUND

The existing foldable handcart comprises a frame having a first end component and an opposing second end component; a chassis component including a first chassis component and a second chassis component, wherein the first chassis component is rotatably connected to the first end component, the second chassis component is rotatably connected to the second end component, and the first chassis component is rotatably connected to the second chassis component; a connecting component connected to the first end component and the second end component, wherein the connecting component has a first connecting member and a second connecting member, the first connecting member is rotatably connected to the first end component, and the second connecting member is rotatably connected to the second end component, wherein the first connecting member is also rotatably connected to the second connecting member; and a flexible shell located on a portion of the frame.

The first connecting member and second connecting member of existing foldable handcart mentioned above are hinged respectively on the same side of the frame, and when at load-bearing state, exert inward torque on the frame, causing uneven load bearing on the frame due to bias towards one side. The overall strength can be further improved.

### SUMMARY

One purpose of the present invention is to address or alleviate the above-mentioned technical problems.

The present invention relates to a foldable cart comprising a functional frame component and a bottom frame component; the functional frame component includes a front functional frame and a rear functional frame; both the front functional frame and rear functional frame are provided with a roller; the front functional frame and/or rear functional frame are provided with a functional member; the bottom frame component includes a front bottom frame and a rear bottom frame; one end of front bottom frame is horizontally hinged to the front functional frame, and one end of rear bottom frame is horizontally hinged to the rear functional frame; the other end of front bottom frame is horizontally hinged, directly or indirectly, to the other end of rear bottom frame, and the foldable cart also comprises a linkage component, wherein the linkage component includes a front linkage rod, a rear linkage rod, and a connecting member. One end of front linkage rod is vertically hinged to one side of the front functional frame, and one end of rear linkage rod is vertically hinged to the other side of the rear functional frame; the front linkage rod and rear linkage rod are parallel to each other and slide linearly with the connecting member, and a horizontal gap is provided between the front linkage rod and rear linkage rod, and the front linkage rod, rear linkage rod, and connecting member are all located below the bottom frame component.

The benefit provided by the present invention is that the present invention can ensure uniform force distribution on the functional frame component while maintaining the stability foldable cart in an unfolded state, and improve the overall strength of functional frame components under the same consumables, and also ensure the stable posture of the front and rear bottom frames being parallel to each other when folded.

In a further technical solution, at least one of the front linkage rod, rear linkage rod, and connecting member is in contact or offset with the bottom frame component to support the bottom frame component.

The technical solution can improve the load-bearing capacity and stability of bottom frame component in the unfolded state.

In a further technical solution, the connecting member is provided with a connecting groove, and the front linkage rod and rear linkage rod are fitted into the connecting groove, or the connecting member is hinged with at least three rows of linear sliding rollers, and the front linkage rod and rear linkage rod are fitted into the gap between the adjacent two rows of linear sliding rollers, respectively.

The technical solution can ensure the reliability of linear sliding connection between the front linkage rod, rear linkage rod, and the connecting member.

In a further technical solution, the linkage component also includes a reinforcing member having a strength greater than that of connecting member; the reinforcing member is in the form of a sheet and is fixedly connected to the top and/or bottom surface of connecting member, or the reinforcing member is cylindrical and sleeved on the connecting member.

The technical solution can improve the strength and load-bearing capacity of connecting member.

In a further technical solution, the front bottom frame and rear bottom frame have the same length; when viewed from above, the front linkage rod, rear linkage rod, and connecting member are rotationally symmetrical about the center of connecting member; the linkage component also includes a connecting wheel that is hinged at the center of connecting member and is respectively fitted on the front linkage rod and rear linkage rod.

The technical solution can ensure smooth linear sliding of the front linkage rod and rear linkage rod.

In a further technical solution, both the front linkage rod and rear linkage rod are provided with linkage teeth; the connecting wheel is a gear that meshes with the linkage teeth.

The technical solution can ensure that the connecting member is centered to prevent the front and rear linkage rods from getting stuck relative to the connecting member, and thus ensuring the smooth unfolding and folding of the foldable cart.

In a further technical solution, the ends of the front linkage rod and rear linkage rod are both provided with limit protrusions, and the limit protrusions in unfolded state are in contact with the side of connecting member.

The technical solution can ensure the connecting member is centered while ensuring the reliability of linkage component.

In a further technical solution, a locking plug is also included, and the locking plug in folded state is embedded between front linkage rod and rear linkage rod.

The technical solution can ensure the folding stability of foldable cart.

In a further technical solution, the bottom frame component includes a rectangular frame shaped middle bottom frame, and the other end of front bottom frame and of rear bottom frame are hinged to the middle bottom frame, respectively, and when folded, both the front bottom frame and rear bottom frame are vertical.

A space between the front and rear bottom frames, when folded, can be used to accommodate objects, providing conveniences.

In a further technical solution, the top and/or bottom of the connecting wheel extend outward to form a connecting wheel rim that is against with the front linkage rod and rear linkage rod, respectively.

The technical solution can improve the torsional and load-bearing capacity of connecting member.

### BRIEF DESCRIPTION OF DRAWINGS

The unfolded state of foldable cart is shown in FIG. 1-3; the folded state of foldable cart is shown in FIG. 10-12 .

FIG. 1 is a 3D schematic diagram of foldable cart in the first embodiment.

FIG. 2 is a 3D schematic diagram of foldable cart in the first embodiment.

FIG. 3 is a 3D schematic diagram of foldable cart in the first embodiment; bottom frame component 2 is not shown.

FIG. 4 is a 3D decomposition diagram of linkage component 3 in the first embodiment.

FIG. 5 is a 3D schematic diagram of connecting member 33 in the first embodiment.

FIG. 6 is a partially sectional schematic diagram of connecting member 33 in the first embodiment.

FIG. 7 is a side view of linkage component 3 in the first embodiment.

FIG. 8 is a schematic diagram of SEC1.

FIG. 9 is a schematic diagram of SEC2.

FIG. 10 is a 3D schematic diagram of foldable cart in the first embodiment.

FIG. 11 is a side view of foldable cart in the first embodiment.

FIG. 12 is a top view of foldable cart of the first embodiment; bottom frame component 2 is not shown.

FIG. 13 is a 3D exploded schematic diagram of connecting member 33 and reinforcing member 36 in the second embodiment.

FIG. 14 is a 3D schematic diagram of connecting member 33 and reinforcing member 36 in the second embodiment.

FIG. 15 is a 3D diagram of bottom frame component 2 in the third embodiment; the circle represents the hinge joints between the middle bottom frame 25, the front bottom frame 21 and rear bottom frame 22, respectively. LINE 1 represents the axis of the hinge joints between the middle bottom frame 25, the bottom frame 21 and rear bottom frame 22, respectively; the dashed line represents the simplified straight state of the front bottom frame 21, rear bottom frame 22, and middle rod clamp 241 in the folded state in the first embodiment.

FIG. 16 is a side view of the connecting wheel 332, front linkage rod 31, and rear linkage rod 32 in the fourth embodiment; the connecting wheel 332 is half sectioned (i.e. a plane from the plane that passes through the axis of connecting wheel 332), and LINE2 represents the axis of connecting wheel 332.

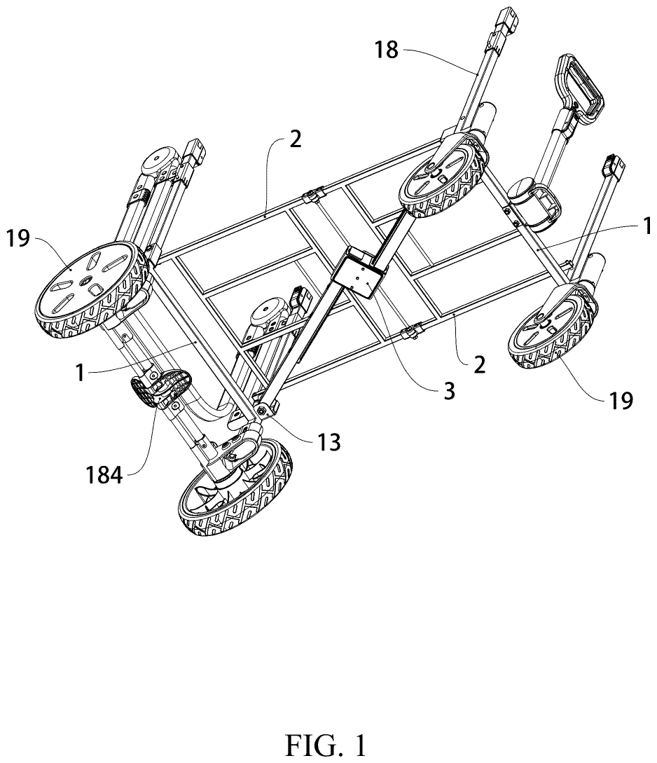

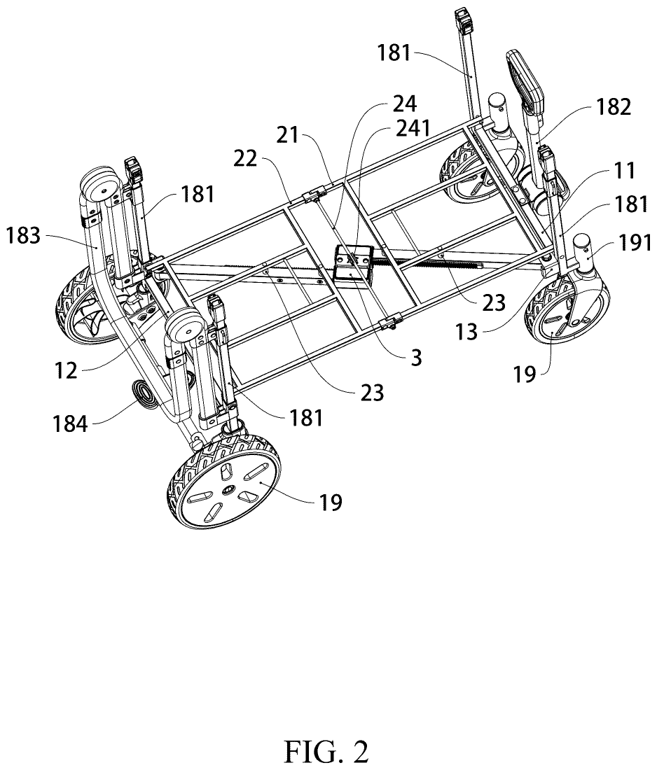

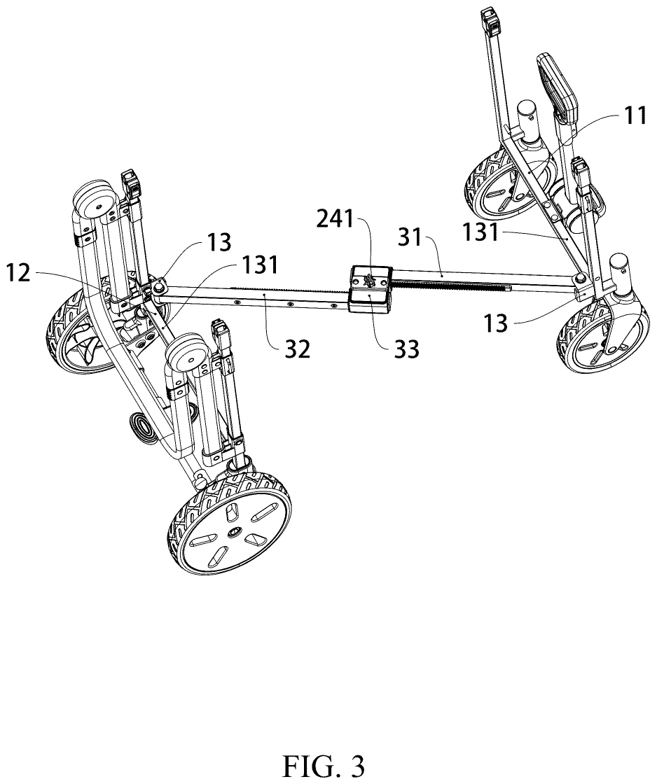

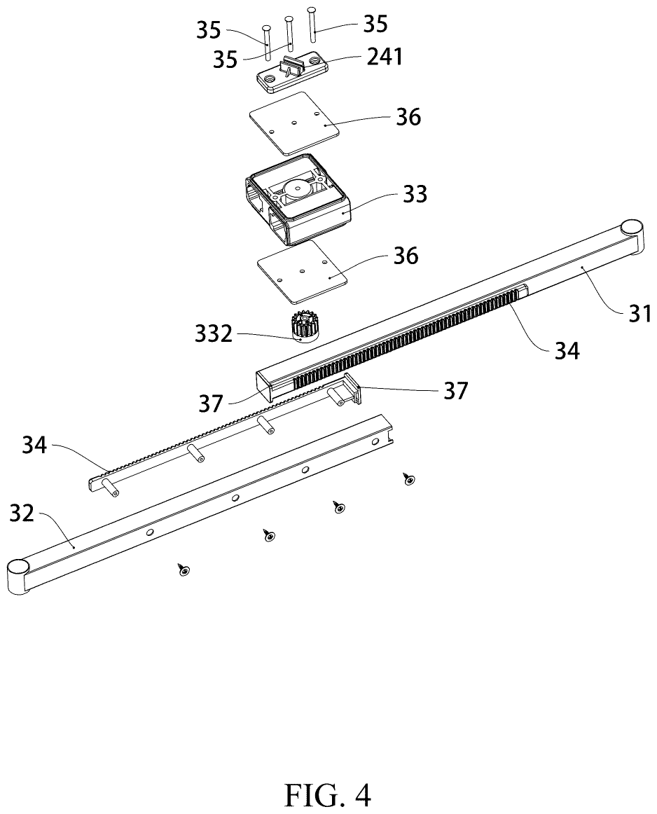

FIG. 3 in the specification is designed as the abstract drawing.

SEC1; SEC2; LINE1; LINE2; Functional frame component 1; Front functional frame 11; rear functional frame 12; Connecting lug 13; Beam 131; Functional member 18; Column 181; Handle 182; Folding support frame 183; Roller brake 184; Roller 19; Universal joint 191; Bottom frame component 2; Front bottom frame 21; Rear bottom frame 22; Support pillar 23; Middle rod 24; Middle rod clamp 241; Middle bottom frame 25; Linkage component 3; Front linkage rod 31; Rear linkage rod 32; Connecting member 33; Connection slot 331; Connecting wheel 332; Connecting wheel flange 333; Connecting wheel groove 334; Linkage teeth 34; Connection pin 35; Reinforcing member 36; Limit protrusion 37; Locking plug 4.

### DESCRIPTION OF EMBODIMENTS

The specific embodiments of the present invention will be described below with reference to the accompanying drawings of the specification.

As a specific embodiment, the foldable cart in the first embodiment includes a functional frame component 1 and a bottom frame component 2.

The functional frame component 1 includes a front functional frame 11 and a rear functional frame 12. In other words, functional frame component 1 includes two functional frames, namely front functional frame 11 and rear functional frame 12. It is easy to understand that the front functional frame 11 and rear functional frame 12 are only relative concepts used for the convenience of distinction and, therefore, although the functional frame with rear handle 182 is usually referred to as front functional frame 11, it is not ruled out that the functional frame with rear handle 182 is referred to as the rear functional frame 12. Similarly, the front bottom frame 21 and rear bottom frame and 22, as well as the front linkage rod 31 and rear linkage rod 32, are also relative concepts used for the convenience of distinction, and it is not ruled out that the bottom frame corresponding to the front bottom frame 21 is called the rear bottom frame 22, or the support rod corresponding to the front linkage rod 31 is called the rear linkage rod 32.

Both the front functional frame 11 and rear functional frame 12 are provided with a roller 19. The front functional frame 11 is connected to the front functional frame 11 through a universal joint 191, so that the roller 19 of the front functional frame 11 can rotate around the vertical axis to achieve universal rotation.

The front functional frame 11 and/or rear functional frame 12 are provided with a functional member 18. The functional member 18 is used to implement specific functions of the cart, for example, including at least one of the column 181, handle 182, folding support frame 183, roller brake 184, etc. The columns 181 are used to support or fix the flexible bags (not shown in the drawing), and the four columns 181 support or fix the four vertical edges of flexible bags to form a rectangular box shape with an open top to accommodate items. The handle 182 connected to the front functional frame 11 can be used to easily pull the foldable cart, and the folding support frame 183 can rotate and fold or open, and can also be used as a support object to pull the foldable cart. The roller brake 184 is used to restrict and unlock the rotation of roller 19, so that the foldable cart can be temporarily fixed and is easy to move. Of course, functional member 18 can also include other structures in prior art that can implement cart functions.

The bottom frame component 2 includes a front bottom frame 21 and a rear bottom frame 22; one end of front bottom frame 21 is horizontally hinged to the front functional frame 11, and one end of rear bottom frame 22 is horizontally hinged to the rear functional frame 12; the other end of front bottom frame 21 is horizontally hinged, directly or indirectly, to the other end of rear bottom frame 22, for example, the other end of front bottom frame 21 and the other end of rear bottom frame 22 are hinged through a pin axis (not indicated in the attached drawing, such as the pin axis being coaxial with the middle rod 24 described later), so that the two are directly hinged horizontally. Horizontal hinge means to set the axis of hinge to be located within a horizontal plane. Therefore, the structure of the aforementioned bottom frame component 2 allows the front bottom frame 21 to rotate in a horizontal straight line relative to the front functional frame 11, the rear bottom frame 22 to rotate in a horizontal straight line relative to the rear functional frame 12, and the front bottom frame 21 to rotate in a horizontal straight line relative to the rear bottom frame 22.

The foldable cart in the first embodiment also comprises a linkage component 3, wherein the linkage component 3 includes a front linkage rod 31, a rear linkage rod 32, and a connecting member 33.

One end of front linkage rod 31 is vertically hinged to one side of the front functional frame 11 (for example, a beam 131 is provided through the front functional frame 11, and both ends of the beam 131 are provided with connecting lugs 13, and one end of the front linkage rod 31 is vertically hinged to one side of the front functional frame 11 through the connecting lugs 13), and one end of rear linkage rod 32 is vertically hinged to the other side of the rear functional frame 12. It is easy to understand that one side of front functional frame 11 is located on the same side as one side of rear functional frame 12, and one side of front functional frame 11 is opposite to the other side of rear functional frame 12.

The front linkage rod 31 and rear linkage rod 32 are parallel to each other and slide linearly with the connecting member 33, a horizontal gap is provided between the front linkage rod 31 and rear linkage rod 32, and the horizontal gap between the front linkage rod 31 and the rear linkage rod 32 ensures that they do not interfere with each other when moving along the connecting member 33.

The front linkage rod 31, rear linkage rod 32, and connecting member 33 are all located below the bottom frame component 2.

The working principle is that the foldable cart has both unfolded state and folded state.

The front bottom frame 21 and rear bottom frame 22 are rotated so that they are both horizontal (the front bottom frame 21 and rear bottom frame 22 are used to support the bottom of flexible bag), and the distance between the front functional frame 11 and rear functional frame 12 is maximized, and the foldable cart is in an unfolded state. The front functional frame 11, front bottom frame 21, rear bottom frame 22, and rear functional frame 12 are all U-shaped and horizontally hinged to the functional frame component 1, while the front bottom frame 21, front linkage rod 31, rear linkage rod 32, and rear bottom frame 22 are all Z-shaped when viewed from above (as shown in FIG. 3) and vertically hinged to the functional frame component 1. The front functional frame 11 or rear functional frame 12 cannot rotate relative to the bottom frame component 2, and the hinge joints between front bottom frame 21 and rear bottom frame 22 (referring to the middle rod clamp 241) will not automatically move upward (in addition, the front bottom frame 21 and rear bottom frame 22 usually also bear the heavy objects inside the flexible bag), ensuring the stable unfolded state of foldable cart; Compared to the prior art in which the front linkage rod 31 and rear linkage rod 32 are both hinged on the same side of functional frame component 1, one end of front linkage rod 31 is vertically hinged to one side of front functional frame 11, and one side of rear linkage rod 32 is vertically hinged to the other side of rear functional frame 12, such that the front floor frame 21, front linkage rod 31, rear linkage rod 32, and rear floor frame 22, when viewed from above, is Z-shaped as a whole, and the inward torque applied by the front linkage rod 31 to the front functional frame 11 and the inward torque applied by the rear linkage rod 32 to the rear functional frame 12 can offset each other, ensuring that the functional frame component 1 is uniformly subjected to force and improving the overall strength of functional frame component 1 under the same consumables.

Move the hinge joint between the front bottom frame 21 and rear bottom frame 22 upwards to tilt both frames to reduce the distance between the front functional frame 11 and rear functional frame 12; during this process, the front functional frame 11, front bottom frame 21, rear bottom frame 22, and rear functional frame 12 form a W-shape that varies with the distance between the front functional frame 11 and rear functional frame 12; the front linkage rod 31 and rear linkage rod 32 slide in a straight line along the connecting piece 33, respectively, while rotating around the connecting lug 13, and when the front functional frame 11, front linkage rod 31, rear linkage rod 32, and rear functional frame 12 are roughly parallel to each other, the distance between the front functional frame 11 and the rear functional frame 12 is minimized, and the foldable cart is in a folded state. The front functional frame 11 or rear functional frame 12 cannot rotate relative to the bottom frame component 2 and, although the hinge point between front bottom frame 21 and rear bottom frame 22 has a downward trend due to own weight, the front bottom frame 21 and rear bottom frame 22 parallel to each other can still be maintained with stable posture when the cart is folded (as shown in the previous section on horizontal hinge and vertical hinge).

As one of the specific embodiments, at least one of the front linkage rod 31, rear linkage rod 32, and connecting member 33 is against or in contact with the bottom frame component 2 to support the bottom frame component 2 and, for example, the bottom surface of front bottom frame 21 and of rear bottom frame 22 are both fixedly provided with support columns 23 which respectively abut against the front linkage rod 31 and the rear linkage rod 32. The support column 23 made of rubber or plastic has a certain degree of flexibility, and is fixed to the front linkage rod 31 and rear linkage rod 32 by screws. The top of connecting member 33 is fixedly provided with a middle rod clamp 241, and the bottom frame component 2 includes a middle rod 24, and the axis of the hinge joint between the front bottom frame 21 and the rear bottom frame 22 is coaxial with the middle rod 24, and the middle rod 24 is fitted into the middle rod clamp 241 to achieve contact, thereby improving the load-bearing capacity and stability of the bottom frame component 2 when unfolded.

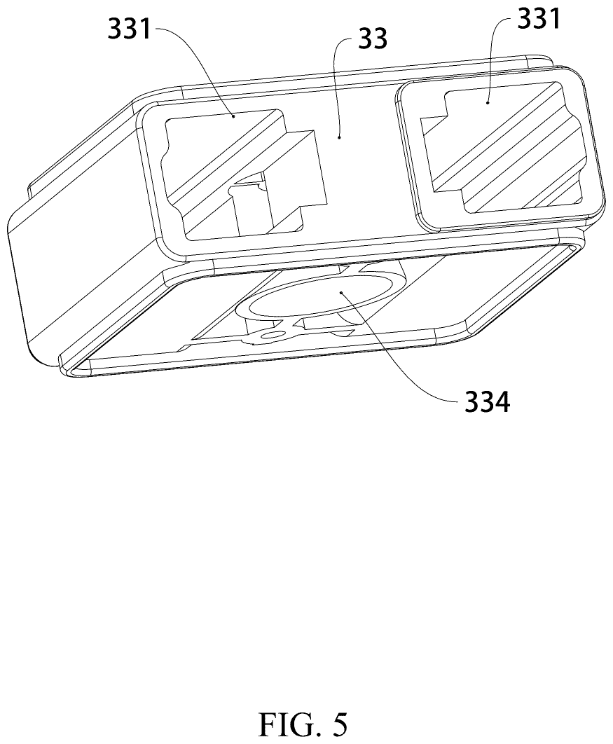

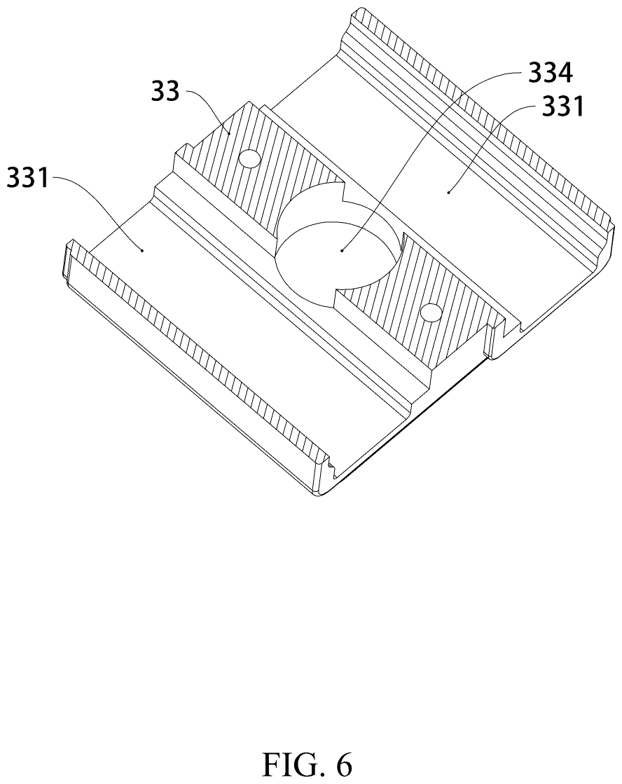

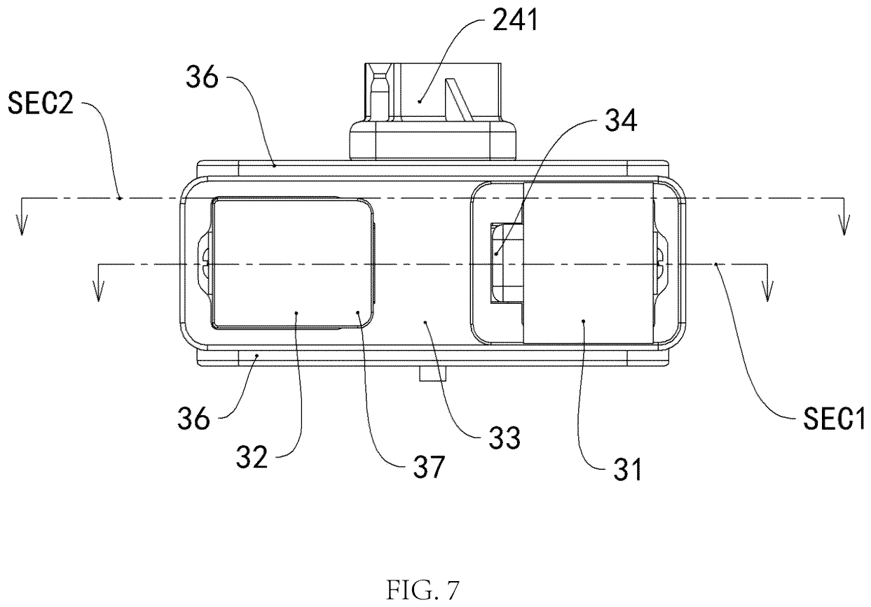

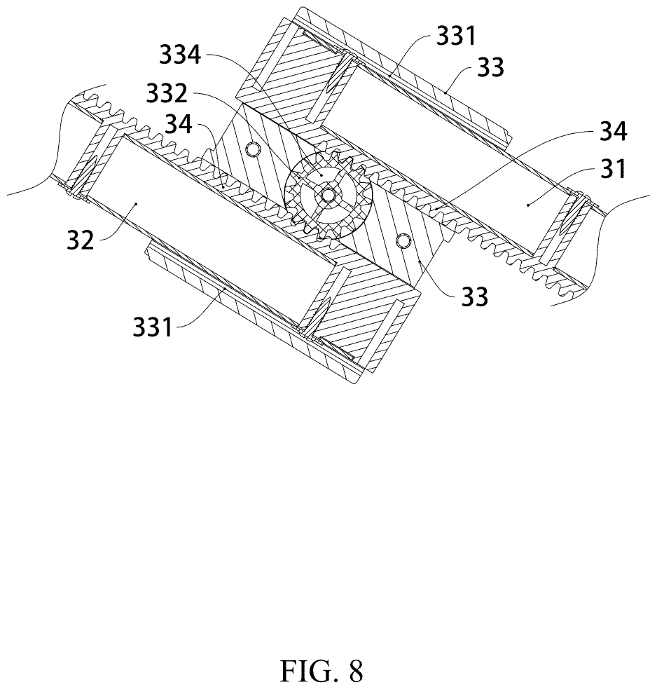

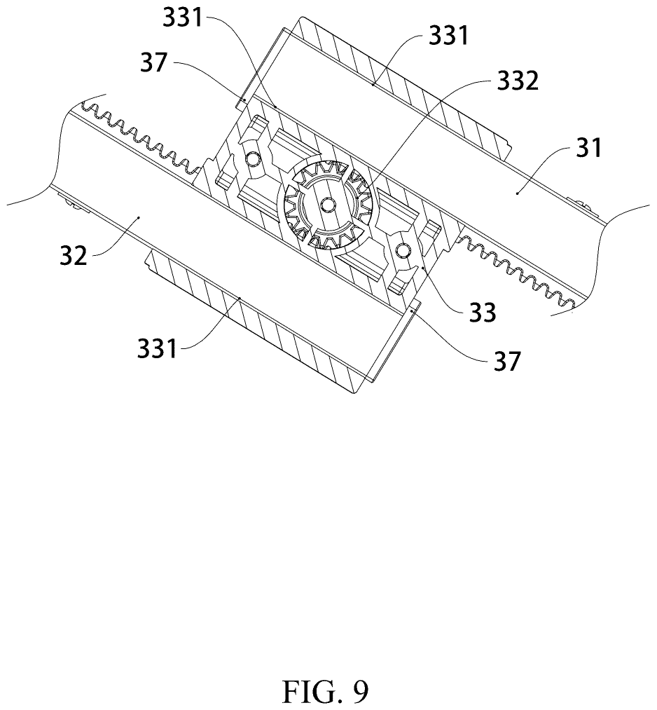

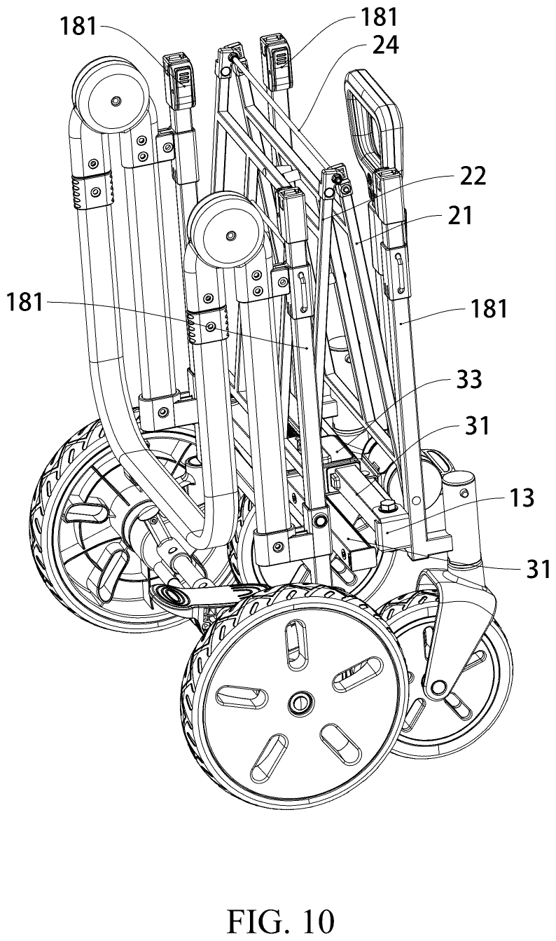

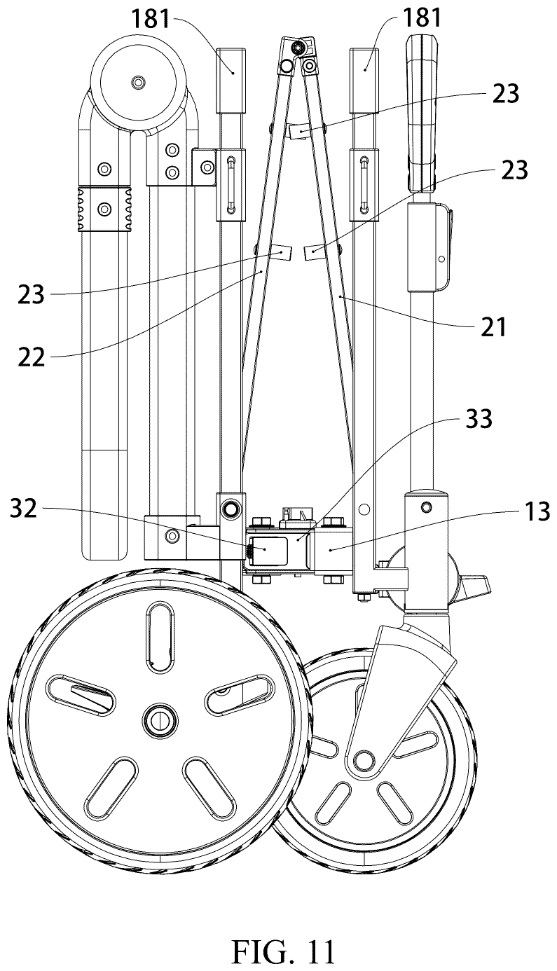

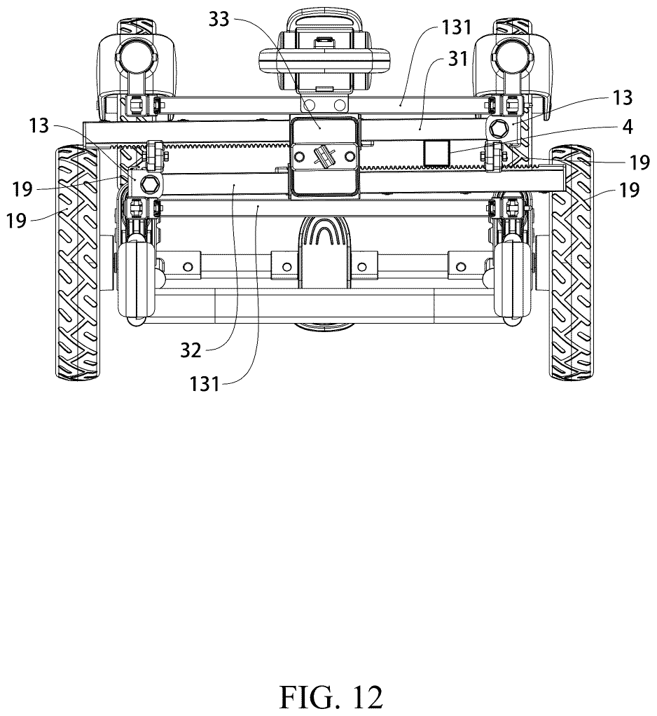

As one of the specific embodiments, the connecting member 33 is provided with a connecting groove 331, and the front linkage rod 31 and rear linkage rod 32 are respectively fitted into the connecting groove 331, such that the front linkage rod 31 and rear linkage rod 32 slide linearly with the connecting member 33, respectively. Alternatively, the connecting member 33 is hinged with at least three rows of linear sliding rollers, (the embodiment of the linear sliding roller is not shown in the attached drawing. The linear sliding roller set along a straight line where a connecting groove 331 is located is a row of linear sliding rollers. As shown in FIG. 5, for example, there are a total of three inner walls on the outer and inner sides of the two connecting grooves 331 of the connecting member 33, and these three inner walls are replaced by the linear sliding roller, and the hinge axis of the linear sliding roller is perpendicular to the top surface of connecting member 33.), and it is easy to understand that there is a gap between the adjacent two rows of linear sliding rollers in the three rows of linear sliding rollers, and the front linkage rod 31 and rear linkage rod 32 are respectively fitted into the gap between the adjacent two rows of linear sliding rollers, such that the front linkage rod 31 and rear linkage rod 32 are respectively connected to the connecting member 33 for linear sliding, ensuring the reliable linear sliding connection between the front linkage rod 31, the rear linkage rod 32, and the connecting member 33.

As one of the specific embodiments, the linkage component 3 further comprises a reinforcing member 36 having a strength greater than that of connecting member 33; for example, connecting member 33 is usually made of plastic, while reinforcing member 36 is made of metal, and the sheet-like reinforcing member 36 is fixedly connected to the top and/or bottom end faces of connecting member 33, improving the strength and load-bearing capacity of connecting member 33.

As one of the specific embodiments, the front bottom frame 21 and rear bottom frame 22 have the same length (the length of the front bottom frame 21 is the distance between the two hinge axis lines of the front bottom frame 21, and the same applies to the rear bottom frame 22); when viewed from above, the front linkage rod 31, rear linkage rod 32, and connecting member 33 are rotationally symmetrical about the center of connecting member 33; the linkage component 3 also includes a connecting wheel 332 that is hinged at the center of connecting member 33 and is respectively fitted on the front linkage rod 31 and rear linkage rod 32, ensuring smooth linear sliding of front linkage rod 31 and rear linkage rod 32. The connecting member 33, for example, is provided with a connecting wheel groove 334 that is connected to the connecting groove 331, and the connecting wheel 332 is provided inside the connecting wheel groove 334; the connecting wheel 332 is hinged to the connecting piece 33 through the connecting pin 35.

As one of the specific embodiments, both the front linkage rod 31 and rear linkage rod 32 are provided with linkage teeth 34; the connecting wheel 332 is a gear that meshes with the linkage teeth 34, ensuring that the connecting member 33 is centered to prevent the front linkage rod 31 and rear linkage rod 32 from getting stuck relative to the connecting member 33, and thus ensuring the smooth unfolding and folding of the foldable cart.

As one of the specific embodiments, the ends of the front linkage rod 31 and rear linkage rod 32 are both provided with limit protrusions 37, and the limit protrusions 37 in unfolded state are in contact with the side of connecting member 33, can prevent the front linkage rod 31 or rear linkage rod 32 from detaching from the connecting member 33, and ensure the reliability of the linkage component 3, the equal length of the front linkage rod 31 and rear linkage rod 32, while ensuring that the connecting member 33 is centered (even if the connecting wheel 332 is not a gear). For the structure where the connecting wheel 332 is a gear matched linkage tooth 34, a toothless segment (not labeled in the attached drawing) is provided at one end of the linkage tooth 34 near the limit protrusion 37. The toothless segment has no teeth, and is set to mesh with the connecting wheel 332 after a distance (such as the distance of one linkage tooth 34) from the beginning of folding. In the unfolded state, the linkage teeth 34 are separated from the connecting wheel 332 and centered by the limit protrusion 37, and both linkage teeth 34 are completely detached from the connecting wheel 332. The position of connecting wheel 332 can be slightly adjusted to achieve accurate rotation angle, so that the linkage teeth 34 can roughly mesh with the two linkage teeth 34 simultaneously from the unfolded state to the folded state, ensuring that the connecting member 33 is centered in both the unfolded and folded states.

As one of the specific embodiments, the foldable cart also has a locking plug, and the locking plug 4 in folded state is embedded between front linkage rod 31 and rear linkage rod 32. The locking plug 4, for example, is a plastic square column, and has a large top to prevent from falling between the front linkage rod 31 and the rear linkage rod 32. When in the folded state, the locking plug 4 is embedded between the front linkage rod 31 and the rear linkage rod 32 to restrict the movement of the front linkage rod 31 and rear linkage rod 32, ensuring the stable folded state of the foldable cart. The locking plug 4 can be pulled out between the front linkage rod 31 and rear linkage rod 32 for convenient locking and unlocking.

The second embodiment is as follows.

The main difference between the foldable cart in the second embodiment and the first embodiment lies in the reinforcing member 36.

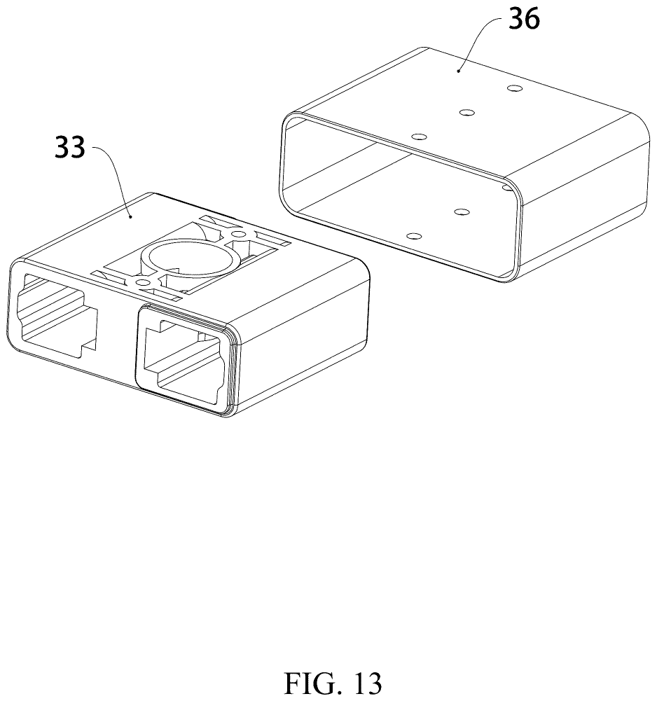

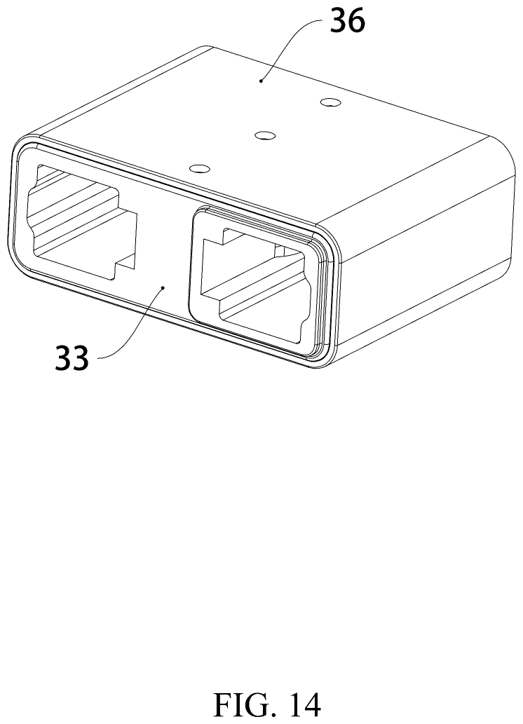

As shown in FIGS. 13 and 14, the reinforcing member 36 in the second embodiment is cylindrical and is fitted onto the connecting member 33, and can further improve the strength and load-bearing capacity of connecting member 33.

The third embodiment is as follows.

The main difference between the foldable cart in the third embodiment and the first embodiment lies in the bottom frame component 2.

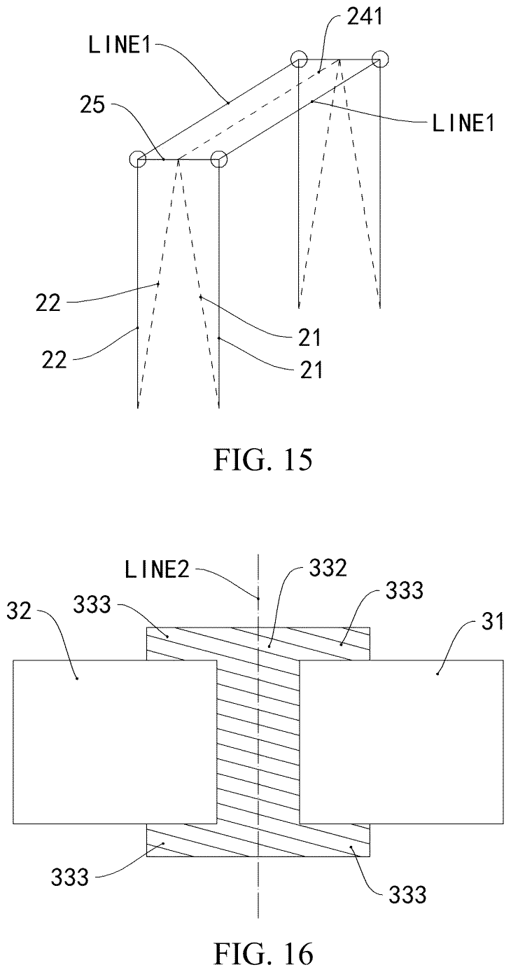

As shown in FIG. 15, the bottom frame component 2 in the third embodiment also includes a rectangular frame shaped middle bottom frame 25 (for example, four straight rods are fixedly connected at the head and tail to form a rectangular frame, and it is easy to understand that the middle portion of the rectangular frame is unobstructed), and the other end of front bottom frame 21 and of rear bottom frame 22 are hinged to the middle bottom frame 25, respectively, the other end of the front bottom frame 21 is indirectly hinged to the other end of the rear bottom frame 22, and when in a folded state, both the front bottom frame 21 and rear bottom frame 22 are vertical, and usually, when viewed from the side, the front bottom frame 21 and rear bottom frame 22 coincide with the column 181, respectively. It is easy to understand that the front bottom frame 21 and rear bottom frame 22 have equal length. When folded, both the front bottom frame 21 and the rear bottom frame 22 are vertical, such that the middle bottom frame 25 is horizontal, and the middle portion of middle bottom frame 25 is unobstructed, and a space between the front bottom frame 21 and the rear bottom frame 22 that can be used to accommodate objects can conveniently accommodate the flexible bag, etc.

The fourth embodiment is as follows.

The main difference between the foldable cart in the fourth embodiment and the first embodiment lies in the connecting wheel 332.

As shown in FIG. 16, the top and/or bottom of the connecting wheel 332 in the fourth embodiment extend outward to form a connecting wheel rim 333 that is against with the front linkage rod 31 and rear linkage rod 32, respectively. For example, the connecting wheel 332 is cylindrical without teeth, and the connecting wheel rim 333 is disc-shaped, and as shown in FIG. 15, the half cut connecting wheel 332 is I-shaped, and can improve the torsional resistance (resisting the twisting force applied by the front linkage rod 31 and rear linkage rod 32 to the connecting member 33) and load-bearing capacity of the connecting piece 33.

The terms used in the present invention, such as “first”, “second”, do not indicate any order, quantity, or importance, but are only used for distinction.

As used in the present invention, terms such as “one”, “one type”, do not indicate a limitation in quantity, but rather indicate the existence of at least one mentioned object.

The terms used in the present invention indicating orientation or position, such as top, bottom, side, longitudinal, transverse, middle, center, outer, inner, horizontal, vertical, left, right, upper, lower, etc., refer to relative position rather than absolute position.

The terms used in the present invention, such as general, as a whole approximate, similar, etc., are intended to indicate limiting terms that have features but allow for certain deviations. The amount of allowable deviation may vary depending on the specific background; deviations in size and specific backgrounds, for example, include but not limit to relevant standards for size tolerances.

What is claimed is:

1. A foldable cart comprises a functional frame component (1) and a bottom frame component (2); the functional frame component (1) includes a front functional frame (11) and a rear functional frame (12); both the front functional frame (11) and rear functional frame (12) are provided with a roller (19); the front functional frame (11) and/or rear functional frame (12) are provided with a functional member (18); the bottom frame component (2) includes a front bottom frame (21) and a rear bottom frame (22); one end of front bottom frame (21) is horizontally hinged to the front functional frame (11), and one end of rear bottom frame (22) is horizontally hinged to the rear functional frame (12); the other end of front bottom frame (21) is horizontally hinged, directly or indirectly, to the other end of rear bottom frame (22), and the foldable cart also comprises a linkage component (3), wherein the linkage component (3) includes a front linkage rod (31), a rear linkage rod (32), and a connecting member (33); one end of front linkage rod (31) is vertically hinged to one side of the front functional frame (11), and one end of rear linkage rod (32) is vertically hinged to the other side of the rear functional frame (12); the front linkage rod (31) and rear linkage rod (32) are parallel to each other and slide linearly with the connecting member (33), and a horizontal gap is provided between the front linkage rod (31) and rear linkage rod (32), and the front linkage rod (31), rear linkage rod (32), and connecting member (33) are all located below the bottom frame component.

2. The foldable cart according to claim 1, wherein at least one of the front linkage rod (31), rear linkage rod (32), and connecting member (33) is against or in contact with the bottom frame component (2) to support the bottom frame component (2).

3. The foldable cart according to claim 1, wherein the connecting member (33) is provided with a connecting groove (331), and the front linkage rod (31) and rear linkage rod (32) are respectively fitted into the connecting groove (331), or the connecting member (33) is hinged with at least three rows of linear sliding rollers, and the front linkage rod (31) and rear linkage rod (32) are respectively fitted into the gap between the adjacent two rows of linear sliding rollers.

4. The foldable cart according to claim 1, wherein the linkage component (3) further comprises a reinforcing member (36) having a strength greater than that of connecting member (33); the reinforcing member (36) is in the form of a sheet and is fixedly connected to the top and/or bottom surface of connecting member (33), or the reinforcing member (36) is cylindrical and sleeved on the connecting member (33).

5. The foldable cart according to claim 1, wherein the front bottom frame (21) and rear bottom frame (22) have the same length; when viewed from above, the front linkage rod (31), rear linkage rod (32), and connecting member (33) are rotationally symmetrical about the center of connecting member (33); the linkage component (3) also includes a connecting wheel (332) that is hinged at the center of connecting member (33) and is respectively fitted on the front linkage rod (31) and rear linkage rod (32).

6. The foldable cart according to claim 5, wherein both the front linkage rod (31) and rear linkage rod (32) are provided with linkage teeth (34); the connecting wheel (332) is a gear that meshes with the linkage teeth (34).

7. The foldable cart according to claim 3, wherein the ends of the front linkage rod (31) and rear linkage rod (32) are both provided with limit protrusions (37), and the limit protrusions (37) in unfolded state are in contact with the side of connecting member (33).

8. The foldable cart according to claim 1, further comprising a locking plug (4), wherein the locking plug (4) in folded state is embedded between the front linkage rod (31) and the rear linkage rod (32).

9. The foldable cart according to claim 5, wherein the bottom frame component (2) includes a rectangular frame shaped middle bottom frame (25), and the other end of front bottom frame (21) and of rear bottom frame (22) are hinged to the middle bottom frame (25), respectively, and when folded, both the front bottom frame (21) and rear bottom frame (22) are vertical.

10. The foldable cart according to claim 5, wherein the top and/or bottom of the connecting wheel (332) extend outward to form a connecting wheel rim (333) that is against with the front linkage rod (31) and rear linkage rod (32), respectively.
